(19) United States
(12) Patent Application Publication
(10) Pub. No.: US 2019/0008711 A1
(43) Pub. Date: Jan. 10, 2019

(54) Slingbar with Multi-Sling Compatibility

(71) Applicant: Liko Research & Development AB, Lulea (SE)

(72) Inventors: Roger Karlsson, Rosvik (SE); John D. Christie, Batesville, IN (US); Jean-Bernard Duvert, Auray (FR); Johan Lyckestig, Lulea (SE); Karin Olsson, Sodra Sunderbyn (SE); Neal Wiggermann, Batesville, IN (US)

(21) Appl. No.: 15/800,694

(22) Filed: Nov. 1, 2017

Related U.S. Application Data
(60) Provisional application No. 62/530,326, filed on Jul. 10, 2017.
(60) Provisional application No. 62/536,036, filed on Jul. 24, 2017.

(51) Int. Cl. A61G 7/10

(52) U.S. Cl. CPC A61G 7/1051; A61G 7/1046

(57) ABSTRACT

A slingbar assembly for supporting a patient includes at least a first slingbar. The first slingbar includes a load bearing frame, at least two spanwisely fixed spacers attached to the frame on opposite sides of a centerplane, and a hub attached to the frame spanwisely between two of the spacers. The slingbar assembly also includes a a strap assembly engaged with the hub. The hub is operable to increase or decrease a working length of the strap assembly. Another embodiment of the slingbar assembly includes a second slingbar substantially the same as the first slingbar, and a connector extending longitudinally between and connected to the slingbars. The connector includes an attachment fixture selectively positionable along the length of the connector so that when the slingbar assembly is supported by a support structure the position of a patient's center of gravity relative to the slingbar assembly can be adjusted.

### CROSS REFERENCE

This application claims priority to U.S. Provisional Applications 62/530,326 filed on Jul. 10, 2017 and 62/536,036 filed on Jul. 24, 2017, the contents of both of which are incorporated herein by reference.

### TECHNICAL FIELD

The subject matter described herein relates to slingbars which are used in combination with a sling to support nonambulatory and semi-ambulatory persons, and particularly a slingbar which is compatible with slings of different sizes.

### BACKGROUND

Caregivers in hospitals and other health care facilities may employ various devices to transport patients suffering from limited mobility, or to assist those patients in their efforts to move about on their own. One such device is a sling assembly. A sling assembly includes a sling made of cloth or other material suitable for cradling the patient. A typical sling includes two or more handle-like loops. A typical sling assembly also includes a slingbar having hooks which receive the loops of the sling. A support structure is used to suspend the sling assembly above floor level. One type of support structure is a freestanding, moveable frame unit which rests on the floor and from which the slingbar can be suspended. Another type of support structure is a carriage which is supported from the ceiling of the facility by a ceiling mounted rail system and which includes an extendable and retractable tether extending downwardly from the carriage. The slingbar may be attached to the lower end of the tether.

Manufacturers typically offer a multitude of different slings to suit patients of different sizes (height, weight) morphologies). Different slings are also provided to address different patient needs such as the need to transport a nonambultory patient and the need to assist a recovering patient's efforts to move about on his own. Manufacturers also offer a variety of slingbars. One characteristic that differs between different slingbar models is the lateral width of the slingbar. Narrow width slingbars are used with smaller slings, wide slingbars are used with larger slings, and one or more intermediate width slingbars are used with various mid-size slings.

The plethora of different slingbars and slings compels care facilities to make large investments in equipment to ensure that the correct combination of sling and slingbar will always be available when needed. The lack of widespread compatibility between slings and slingbars increases the likelihood of caregiver error, i.e. choosing a suboptimal sling/slingbar combination. The need to manufacture multiple models of slingbars also imposes additional financial burdens and operational complexity on manufacturers.

It is therefore desirable to provide a slingbar which is compatible with a wide array of sling models, which helps mitigate the possibility of caregiver error, and which reduces financial and operational burdens on users and manufacturers.

### SUMMARY

[symbol]

### BRIEF DESCRIPTION OF THE DRAWINGS

The foregoing and other features of the various embodiments of the slingbar described herein will become more apparent from the following detailed description and the accompanying drawings in which:

FIG. 1A is a perspective view showing a slingbar assembly as described herein.

FIGS. 1B and 1C are elevation views of two possible support structures for suspending the slingbar assembly of FIG. 1A above the floor.

FIG. 1D is an enlarged view of a portion of the slingbar assembly of FIG. 1A.

FIG. 2 is a view of a slingbar as described herein as seen from the front.

FIG. 3 is a close-up view of the slingbar of FIG. 2 as seen from the side.

FIG. 4 is a schematic view of a hub component of the slingbar.

FIG. 5 is a view of a lock pin of FIG. 4 and a strap sewn to itself to form a loop which circumscribes the pin.

FIGS. 6, 7 and 8 are front elevation views showing a strap assembly draped over inboard, intermediate and outboard spacers of the slingbar.

FIG. 9 is a schematic elevation view showing a strap at two different working lengths.

FIGS. 10A, 10B, 10C, 10D, 10E, 10F, and 10G are views of an embodiment of the slingbar device with only two left spacers and two right spacers, and showing left and right portions of the strap assembly draped over the inboard spacers (FIGS. 10A and 10B) and over the outboard spacers (FIGS. 10C, 10D, 10E, 10F, and 10G.

FIG. 11 is a view of a spool component of the slingbar showing a strap assembly in the form of a single strap fully extended (solid) and partially wrapped around the spool (phantom).

FIGS. 12A, 12B, 12C, 12D, 12E, 12F, and 12G are views of a fixation device for regulating rotation of a spool component of the slingbar assembly.

FIG. 13 is a perspective view similar to FIG. 1 showing an embodiment of the slingbar assembly which includes two slingbars and a connector connected to the slingbars.

FIG. 14 is a schematic view showing a slingbar assembly and a sling whose loops are hooked onto hooks of the slingbar.

FIGS. 15 and 16 are an elevation view and a plan view of a portion of the connector of FIG. 13.

FIGS. 17, 18 and 19 are elevation views of slingbar hooks illustrating the unlikelihood that the sling loops will slip out of the hooks.

FIGS. 20, 21 and 22 are elevation views of hooks of the type typically used at the left and right ends of a slingbar.

FIGS. 23A, 23B and 23C are a plan view, a front elevation view and a cross section along 23C-23C of FIG. 23B showing another embodiment of a slingbar.

FIGS. 24A, 24B and 24C are a plan view, a front elevation view and a side elevation view of yet another embodiment of a slingbar.

### DETAILED DESCRIPTION

Reference will now be made to embodiments of the invention, examples of which are illustrated in the accompanying drawings. Features similar to or the same as features already described may be identified by the same reference numerals already used. The terms “substantially” and “about” may be used herein to represent the inherent degree of uncertainty that may be attributed to any quantitative comparison, value, measurement or other representation. These terms are also used herein to represent the degree by which a quantitative representation may vary from a stated reference without resulting in a change in the basic function of the subject matter at issue.

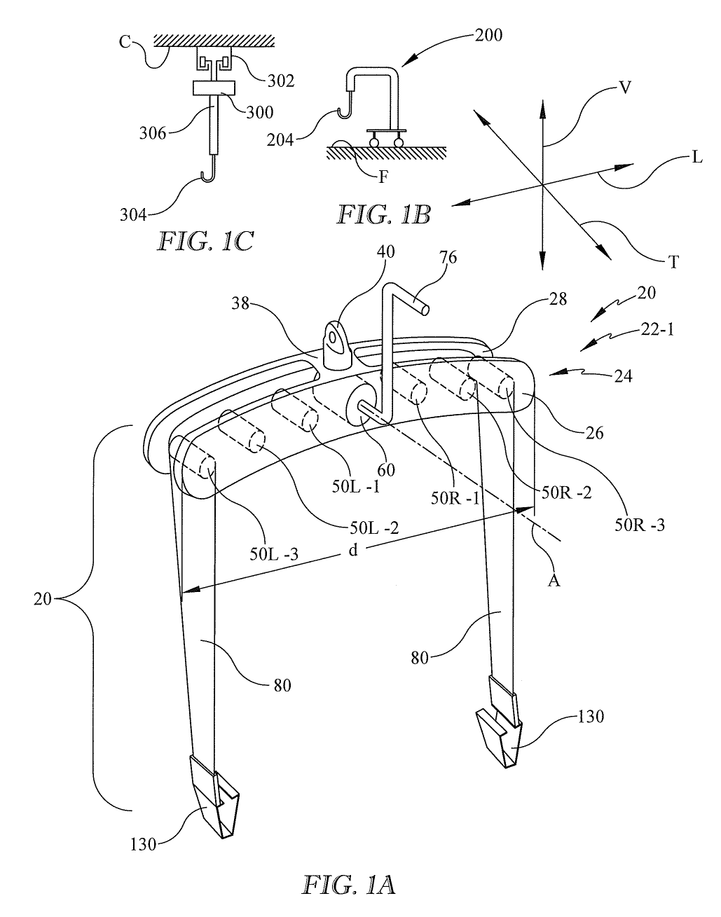

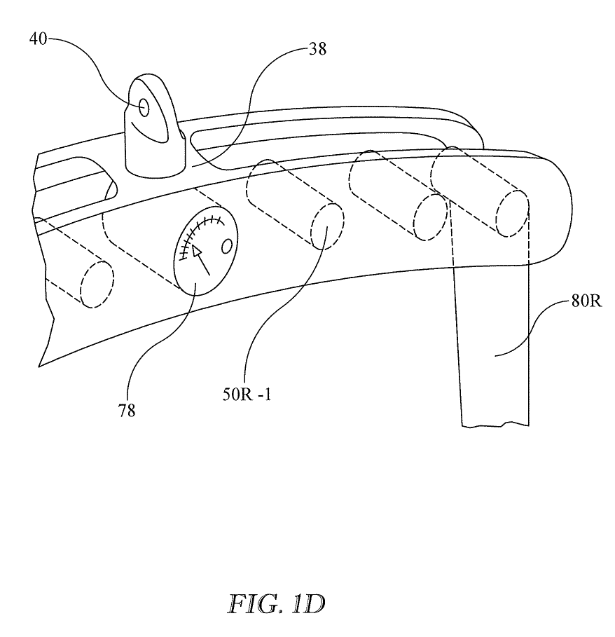

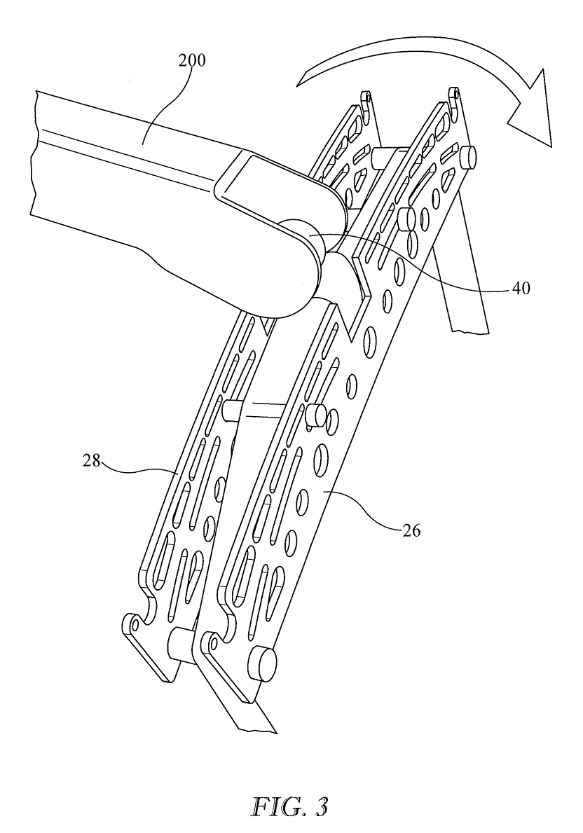

Referring to FIGS. 1-5 a slingbar assembly 20 includes a first slingbar 22-1 which includes a load bearing frame 24 comprised of front and back beams 26, 28. The frame has a lateral or spanwise dimension d, and extends laterally leftwardly and rightwardly from a centerplane 36 (depicted in FIG. 4). FIG. 1A also shows lateral, vertical, and transverse axes, L, V, T.

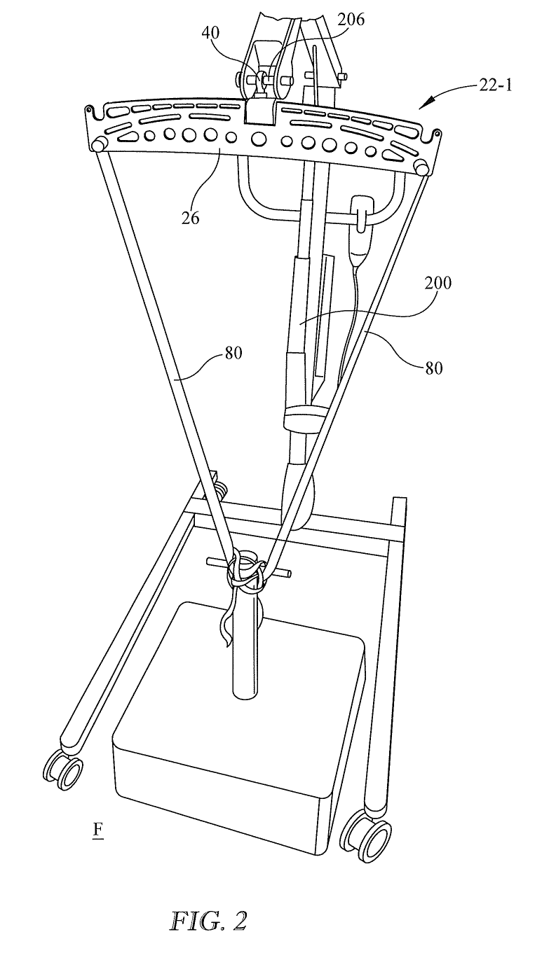

The slingbar frame also includes a web 38 extending transversely between beams 26, 28. An eye 40 projects vertically upwardly from the web. The slingbar may be used with a moveable frame unit 200 which rests on a floor F, in which case eye 40 receives an attachment member such as hook 204 (FIG. 1B) or pin 206 (FIG. 2) attached to the frame unit in order to suspend the slingbar assembly above the floor. As seen in FIG. 1C, the slingbar may also be used with a carriage 300 which is moveable along a rail 302 mounted on ceiling C. In that case eye 40 receives an attachment member such as hook 304 attached to a tether 306 which extends from the carriage.

The slingbar assembly also includes at least two transversely extending spacers 50 attached to the beams on laterally opposite sides of the centerplane at spanwisely fixed locations. The spacers are distributed symmetrically and equally in number on either side of the centerplane.

The illustrated embodiment includes six cylindrical spacers, three on the left side of the centerplane (50L-1, 50L-2, 50L-3) and three on the right (50R-1, 50R-2, 50R-3). Left and right spacers with numerically equal suffixes (-1, -2 or -3) are referred to herein as spacers of equal ordinality.

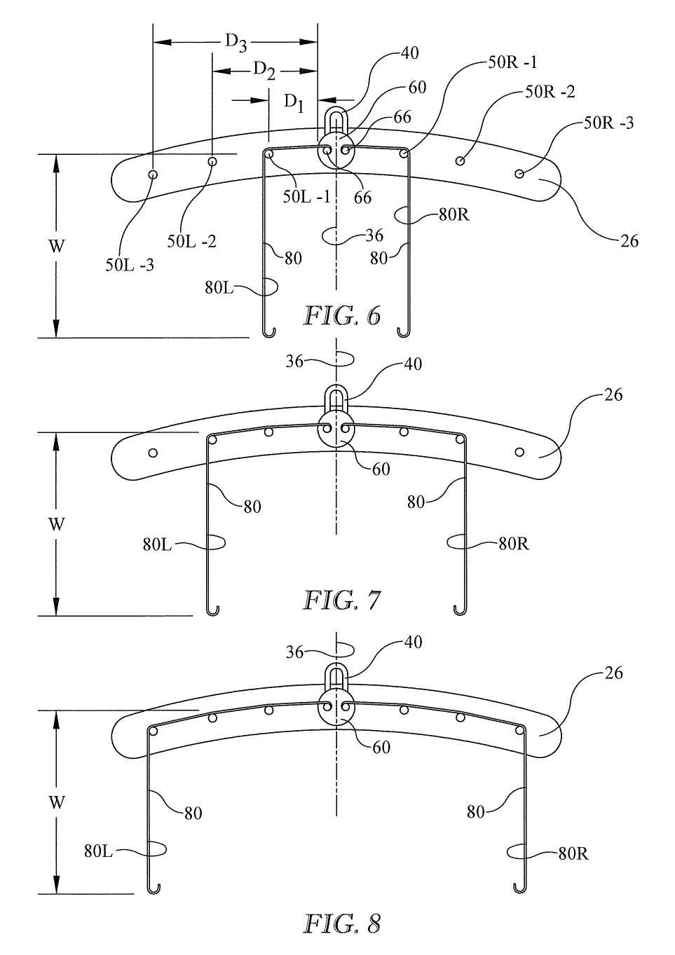

In the illustrated embodiment spacers of equal ordinality are equidistant from the centerplane. As seen best in FIGS. 6-9, the -1, -2 and -3 spacers are located distances D₁, D₂ and D₃ respectively from the nearest edge of spool 62.

The slingbar assembly also includes a hub 60 attached to beams 26, 28 at a location spanwisely between two of the spacers, and a strap assembly 80. In the illustrated slingbar assembly the hub is at centerplane 36, between inboardmost spacers 50L-1 and 50R-1. The hub includes a spool 62 having a spool axle 64, and a recess 68 having an opening 72. Alternatively, the axle can be supported in a way that does not require an axel to penetrate through the spool in the transverse direction. For example the spool can be supported by a set of bearings, one at the front end of the spool and one at the back end of the spool. A pair of lock pins 66, each trapped in a spool recess 68, engages the strap assembly with the hub so that the strap assembly cannot pull free from the hub. The spool is rotatable about a horizontal, nonspanwisely extending rotational axis A, for example by rotation of crank 76.

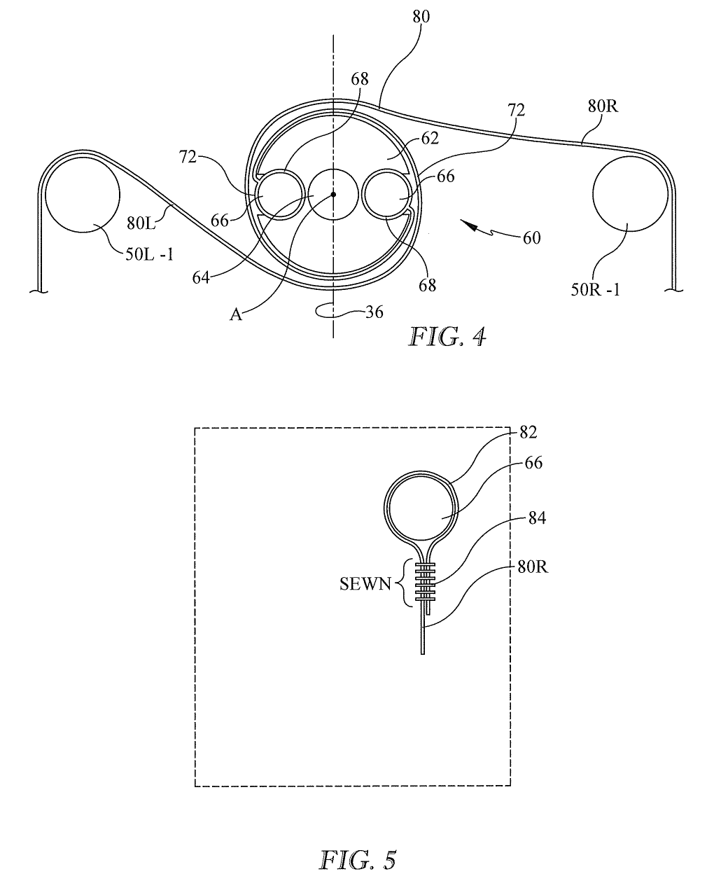

Referring principally to FIGS. 4-5, the strap assembly 80 comprises a left strap 80L and a right strap 80R. One end of each strap is formed into a loop 82, for example by sewing, represented in the illustration by stitches 84. The loop circumscribes its lock pin 66 so that the strap extends out of the opening 72 in the spool recess 68.

Hub 60 is operable, for example by crank 76, so that the strap assembly can be wound onto the spool (also referred to as retracting the strap) and unwound from the spool (also referred to as deploying or extending the strap). Rotation of the spool in one of two rotational senses (clockwise or counterclockwise) winds the strap assembly onto the spool whereas rotation of the hub in the opposite direction unwinds the strap assembly from the spool. As seen best in FIG. 1D, the hub may include an indicator 78 to show the extent to which the strap has been unwound from the spool.

The strap assembly extends spanwisely away from the hub and drapes over a spacer 50L on one side of the centerplane and over a spacer 50R on the opposite side of the centerplane. The spacers over which the strap assembly is draped are referred to as the width governing spacers. The width governing spacers are selected by a user, such as a caregiver, and are typically selected to be spacers of equal ordinality. FIG. 6 shows a slingbar assembly whose strap assembly comprises dual (left and right) straps 80L, 80R and in which a caregiver has draped each strap over the inboardmost spacers 50L-1 and 50R-1. As a result, each strap has a working length W which is the distance from the -1 spacer to the free end of the strap. FIG. 7 is a similar view in which the caregiver has draped each strap over one of the intermediate spacers (-2 suffix) and has operated the hub to unwind the straps from the spool by an amount which, neglecting the slight vertical distance between the -1 and -2 spacers, equals the inter-spacer distance D₂-D₁. As a result, the working length W of FIG. 7 is the same as that of FIG. 6. FIG. 8 is another similar view in which the caregiver has draped each strap over one of the outboardmost spacers and has operated hub 60 to unwind the straps from the spool by an additional amount which, neglecting the sight vertical distance between the -2 and -3 spacers, equals the inter-spacer distance D₃-D₂. The working length W is therefore the same as in FIGS. 6-7.

Notwithstanding the equal working lengths depicted in FIGS. 6-8, the user may select whatever combination of spacers and amount of strap retraction or deployment yields a strap working length best suited to the task at hand.

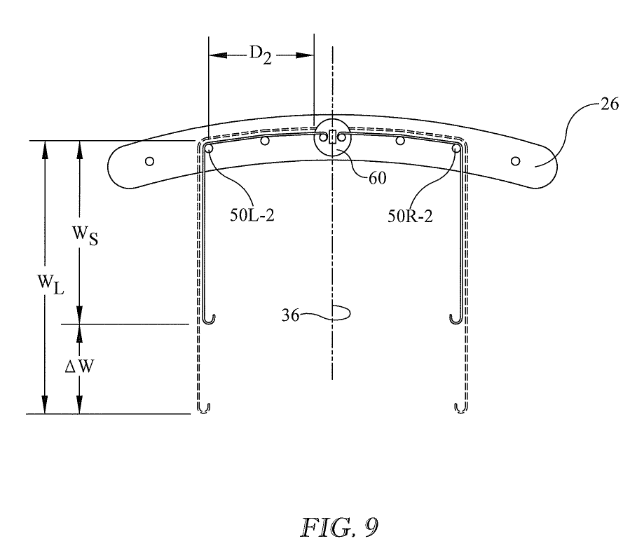

The working length is a function of which spacers have been selected to be the width governing spacers, and the extent to which the left and right straps have been deployed or retracted. FIG. 9 shows an example in which a user has selected spacers 50L-2 and 50R-2 as the width governing spacers. The straps depicted with solid lines have a relatively shorter working length W_{S}. The straps depicted with dashed lines have a relatively longer working length W_{L}. The difference in working length is attributable to ΔW, the additional length of strap deployed from the spool to increase the working length from W_{S} to W_{L} or the additional length of strap retracted onto the spool to decrease the working length from W_{L} to W_{S}.

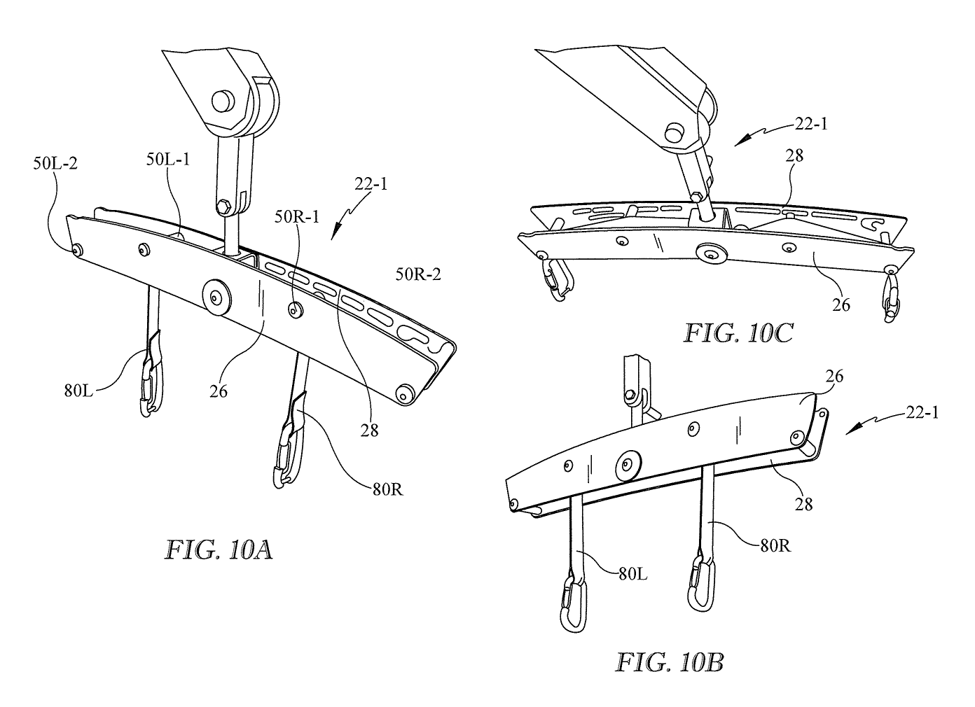

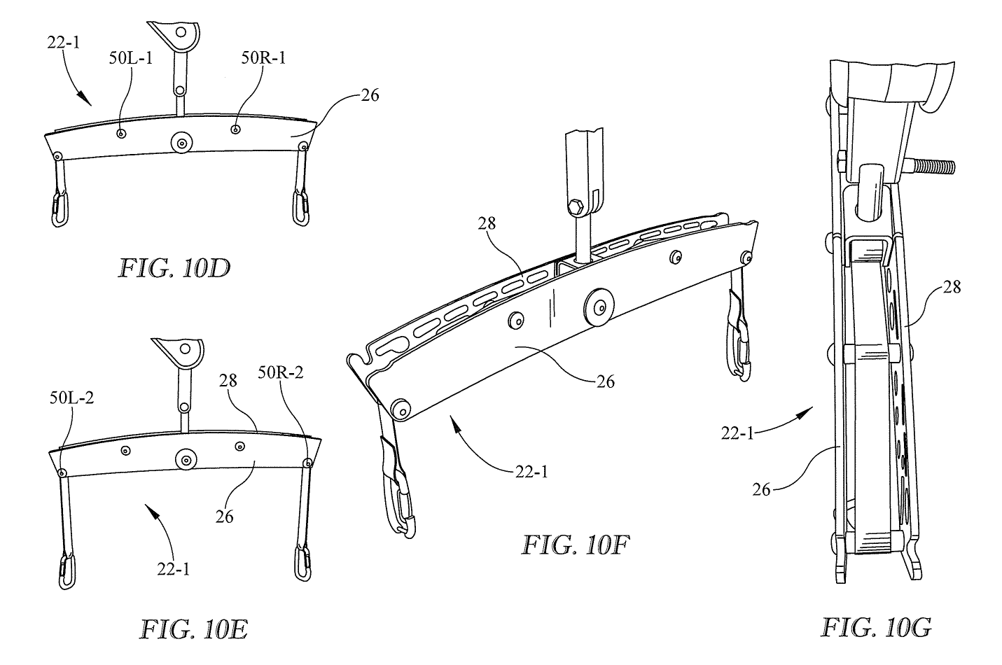

FIGS. 10A and 10B are views of an embodiment of the slingbar assembly taken from different perspectives. The illustrated first slingbar 22-1 includes only two left spacers, 50L-1, 50L-2 and two right spacers 50R-1 and 50R-2 rather than three left spacers and three right spacers as in the previous examples. Straps 80L and 80R are draped over the inboard (-1 suffix) spacers. FIGS. 10C through 10G show the same embodiment with the straps draped over the outboard spacers (-2 suffix).

In the foregoing examples strap assembly 80 is in the form of a set of two straps, a left strap 80L and a right strap 80R. FIG. 11 shows a functionally equivalent alternative in which the strap assembly 80 is a single strap having a left portion 80LP and a right portion 80RP. Anchors 86 prevent the strap assembly from slipping through the hub in the direction of arrow S. The unshaded solid line depiction shows the strap assembly fully deployed. The shaded phantom line depiction shows part of the strap assembly wrapped around the spool as a result of approximately one clockwise rotation of the spool (the difference in shading is to help the reader distinguish between the left and right portions).

The slingbar may also include a clamp, lock or other fixation device for regulating rotation of the hub, and therefore extension and retraction of the strap assembly. One example of a fixation device is a ratchet.

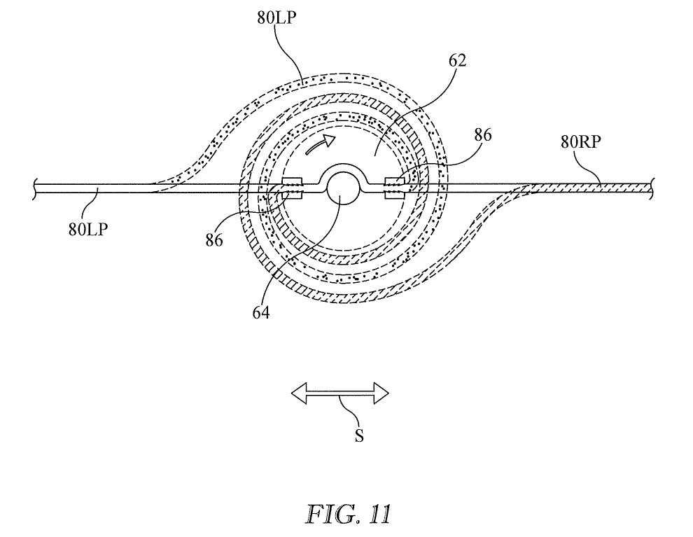

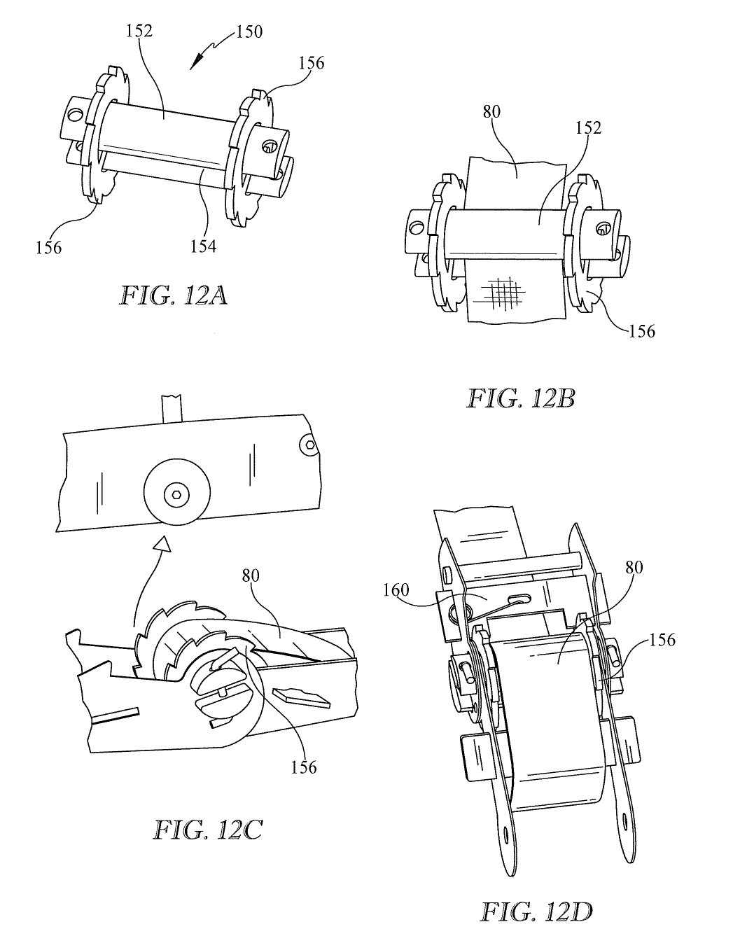

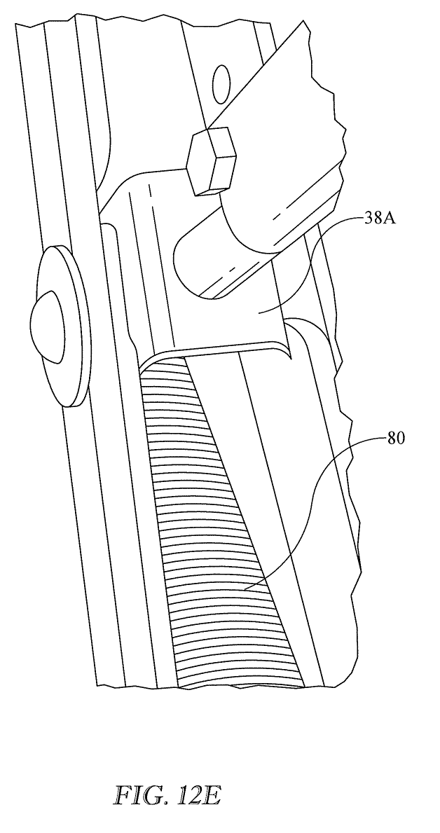

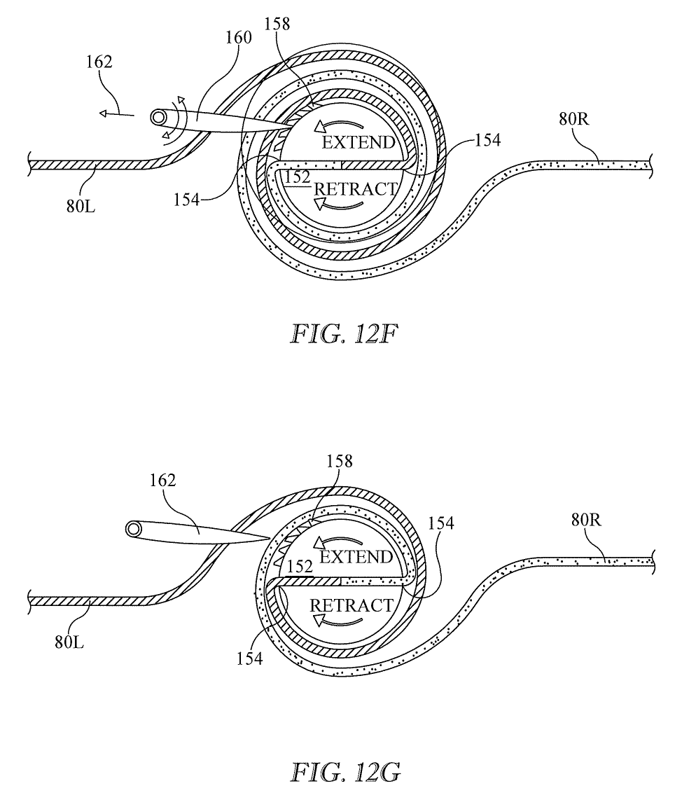

Referring to FIGS. 12A through 12G, hub 60 includes a ratchet 150. The ratchet includes a shaft 152 with a slot 154 therein and a pair of ratchet wheels 156. FIG. 12A shows the ratchet standing alone. FIG. 12B shows the ratchet with a strap assembly 80 threaded through the slot. FIG. 12C shows the ratchet with the strap assembly threaded through the slot and partially wrapped around the shaft. FIG. 12D is similar to FIG. 12C but also shows a pawl 160. FIG. 12E shows an embodiment of a slingbar, such as first slingbar 22, in which a bracket 38A, rather than a web 38 (FIG. 1) extends transversely between front and back beams 26, 28. The ratchet, not visible in FIG. 12E, resides beneath the bracket. In the embodiment of FIGS. 1A and 1D, the ratchet resides beneath the web.

Referring to FIG. 12F, when pawl 160 is engaged with teeth 158 of the ratchet wheel (only some of which are illustrated) the ratchet shaft will not rotate in the EXTEND direction and therefore will not allow a change in the working lengths of the left and right portions 80L, 80R of the strap assembly. (Portions 80L, 80R are shaded differently in the illustration merely to make it easier for the reader to distinguish one portion from the other.) If the slingbar is supporting the weight of a patient, the patient will be held securely against gravity. However the ratchet will permit a caregiver to rotate the shaft in the RETRACT direction. In order to extend the strap assembly, a caregiver releases the pawl from the ratchet teeth as indicated by arrow 162 of FIG. 12F. FIG. 12G shows the pawl released from the ratchet teeth and the shaft 152 having been rotated one half revolution in the EXTEND direction to cause extension of strap portions 80L, 80R and an attendant increase in their working length. In practice the pawl will be re-engaged with the ratchet teeth before patient weight is applied to the slingbar.

Although a user can drape the strap over left and right spacers of different ordinality, it is anticipated that the user will typically use spacers of equal ordinality. If there are at least two spacers to one side of the centerplane and an equal number to the other side, it may therefore be desirable to visually code spacers of equal ordinality on opposite sides of the centerplane. One way to provide visual coding is to color code either the spacers themselves or the beams 26, 28 in the vicinity of the spacers. For example the inboard spacers (-1 suffix) may be colored red, the intermediate spacers (-2 suffix) green and the outboard spacers (-3 suffix) yellow.

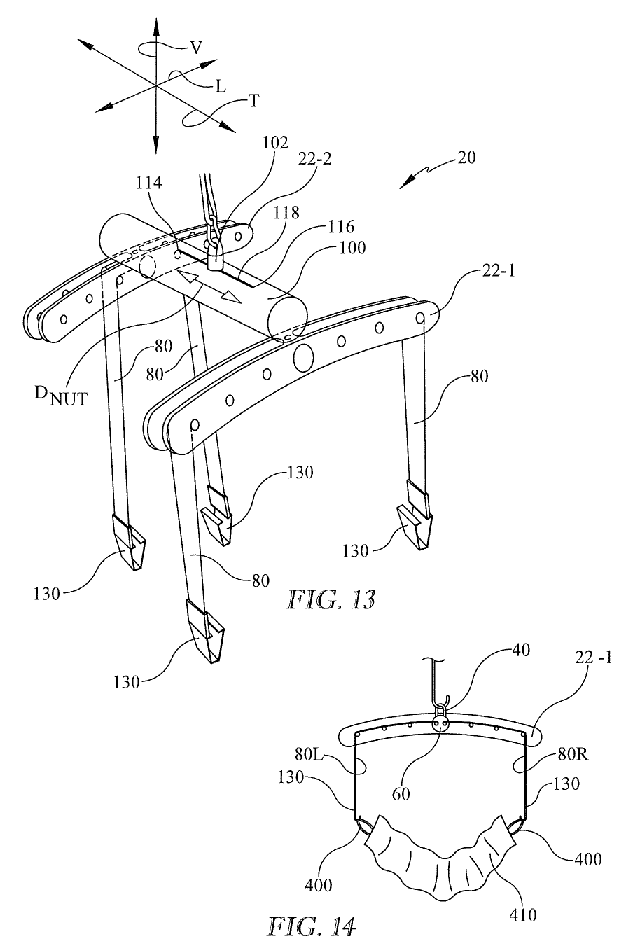

FIG. 13 shows a sling assembly which includes a second slingbar 22-2 substantially the same as first slingbar 22-1 and a connector 100 extending transversely between the slingbars. The connector is removably connectable to the slingbars. In one example, not illustrated, each end of the connector is adapted to mate with eye 40 (FIG. 1) of a slingbar. However in the example of FIG. 13, the connector is connected directly to web 38 without an intervening eye. In such a directly connected arrangement the slingbar may be one whose eye is removable or may be one that was manufactured without an eye.

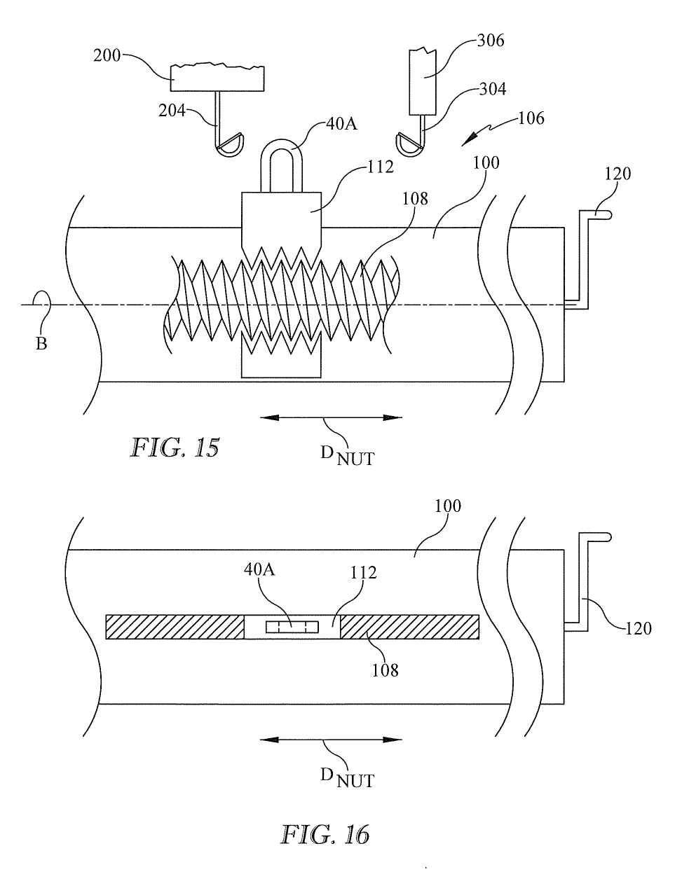

The connector includes an attachment fixture 102 selectively positionable along a portion of the length of the connector, for example from end 114 to end 116 of slot 118. Referring additionally to FIGS. 15-16, one way of providing the selective positioning is by way of a leadscrew assembly 106 comprised of a leadscrew 108 rotatable about axis B and a nonrotatable leadscrew nut 112 which is translatable in direction DNUT. The nut includes an eye 40A similar to eye 40 of FIG. 1. Eye 40A receives an attachment member such as hook 204 attached to frame unit 200 (FIG. 1B) or a hook 304 at the free end of a tether 306 (FIG. 1C). Either way, when the slingbar is in use to bear the weight of a patient, the eye is a suspension point.

By causing the leadscrew nut to translate along the connector (e.g. by rotating the leadscrew with crank 120) a user can move the location of the suspension point in relation to the first and second slingbars, and therefore in relation to the patient's center of gravity. This allows the patient's orientation to be adjusted. For example a patient who is in an orientation similar to a normal sitting posture when the nut is at some particular position along the connector can be tilted back or tilted forward by translating the nut along the leadscrew.

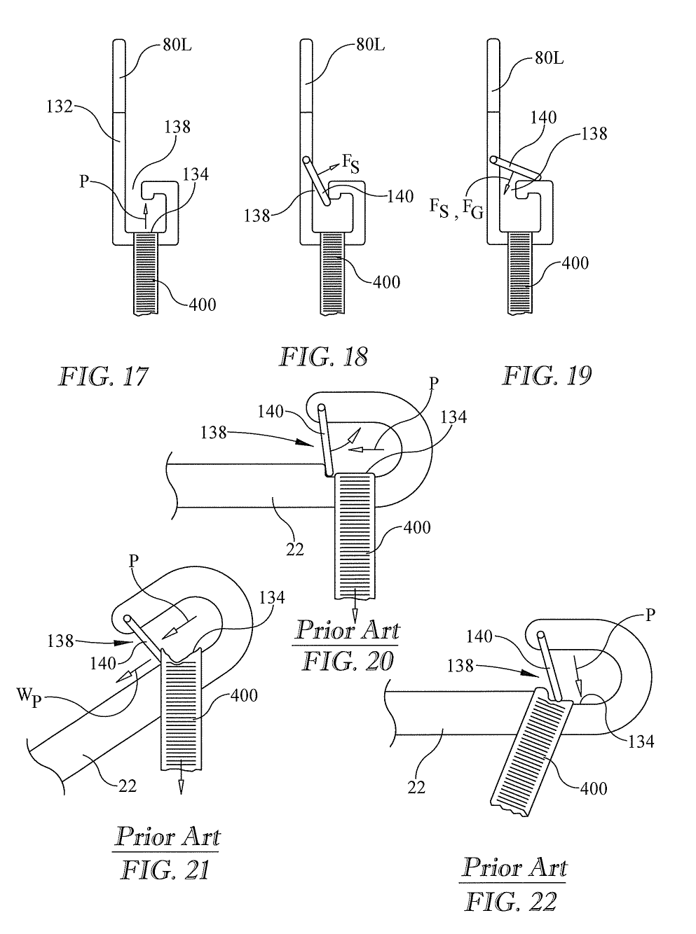

As seen in FIGS. 1, 13, and 14 strap assembly 80 includes a pair of hooks 130, one on the right strap (or right portion of a single strap) and one on the left strap (or left portion of a single strap). Referring additionally to FIGS. 17-19, the hook has a shank 132 and a load bearing seat 134 which bears patient weight transferred to the hook by a loop 400 of a sling 410. The hook also includes an opening 138 through which the sling loop 400 is inserted or removed. The hook of FIG. 17 is ungated. The hook of FIG. 18 includes a gate 140 which is spring loaded closed by a spring force F_{S} which rotationally biases the gate toward an orientation more perpendicular than parallel to the shank. The hook of FIG. 19 includes a gate 140 which is spring loaded closed by a spring force F_{S} which rotationally biases the gate toward an orientation more parallel than perpendicular to the shank. In the illustrated orientation gravitational force would also suffice to urge the gate of FIG. 17 to its closed position.

Irrespective of whether the hook is gated or ungated, the hook hangs plumb from the strap, i.e. its shank hangs vertically, and the load bearing seat 134 is vertically below opening 138. The relationship between the seat and the opening can also be described as a 180 degree offset relationship because a pointer P initially pointing at either seat 134 or at opening 138 must be rotated 180 degrees in the plane of the paper in order to point at the other. As a result, the likelihood of the sling loop slipping out of the hook, either through the ungated opening or by exerting enough force on gate 140 to break it, is reduced. Referring additionally to FIGS. 20-22, this is in contrast to conventional hooks of the type used at the lateral ends of many slingbars. FIG. 20 shows how even with the slingbar 22 in a typical, substantially horizontal orientation, a pointer P initially pointing at either the seat 134 or the opening 138 need be rotated only 90 degrees in the plane of the paper in order to point at the other. FIG. 21 shows that if the slingbar, while bearing patient weight, is at a nonhorizontal orientation, part of the weight W_{P} borne by the slingbar can be imposed on gate 140 with an attendant risk that the gate will fail. FIG. 22 shows a 90 degree offset arrangement in which the strap is caught between the seat and the gate, once again elevating the likelihood that loop 400 might slip free from the hook.

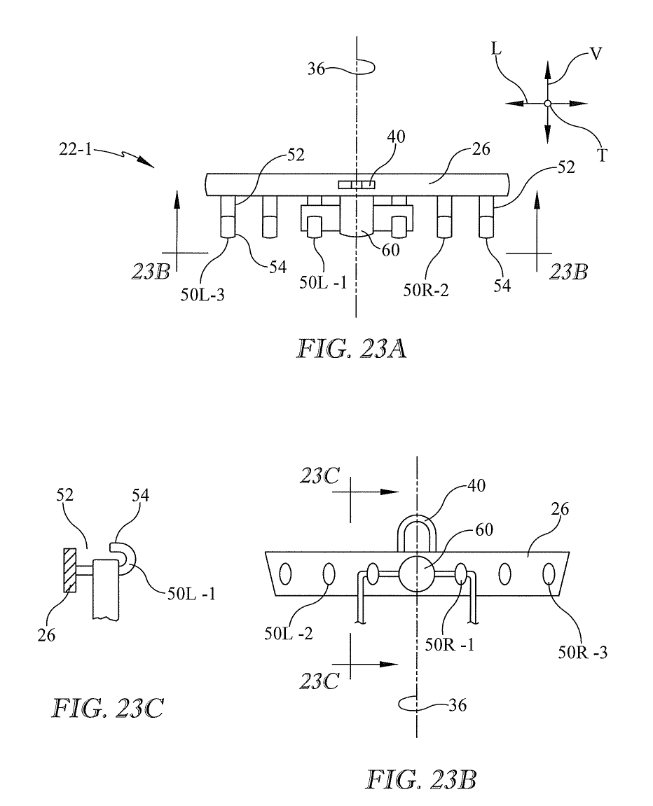

FIGS. 23A, 23B and 23C show another embodiment in which the first slingbar 22-1 of the slingbar assembly includes only a single beam, shown as beam 26. Spacers 50L, 50R each have a proximal end 52 joined to the beam and a distal end 54 not joined to the beam so that the spacers project transversely from the beam in a cantilevered fashion. As seen best in FIG. 23C each spacer is in the form of a hook. The left and right portions 80L and 80R of the strap assembly extend from hub 60 and drape over a spacer selected by a caregiver. In the illustration the strap assembly portions are draped over spacers 50L-1 and 50R-1.

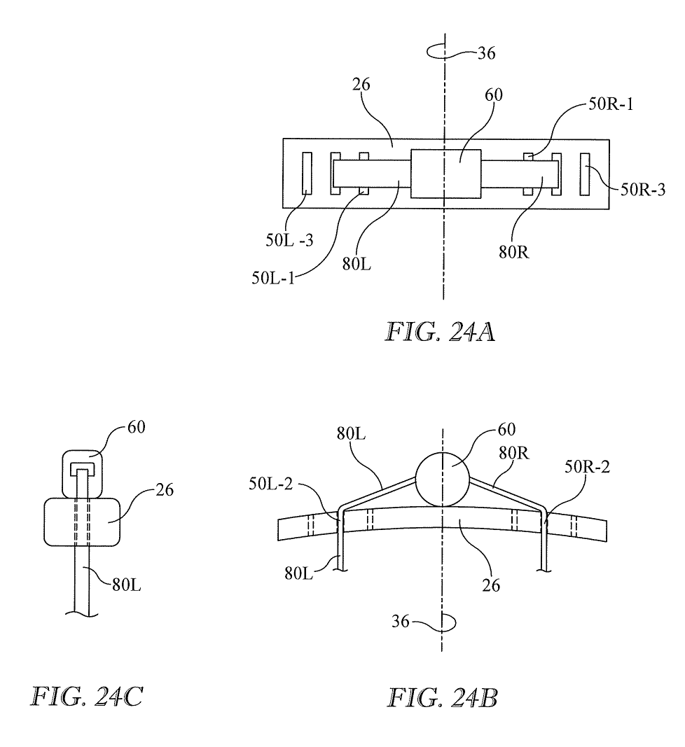

FIGS. 24A, 24B and 24C show another embodiment in which beam 26 includes a series of slots 50L, 50R which penetrate through the beam. The left and right portions 80L and 80R of the strap assembly extend from hub 60 and pass through a slot selected by a caregiver. In the illustration the strap assembly portions are threaded through slots 50L-2 and 50R-2.

This specification, including the accompanying claims, uses “left”, “right”, “front”, and “back” as terms of distinction, for example to distinguish between straps 80L and 80R or between beams 26 and 28. Because of the symmetry of the sling assembly about a plane parallel to the V-L plane and about a plane parallel to the V-T plane, the choices of “left” and “right” can be reversed and/or the choices of “front” and “back” can be reversed.

Although this disclosure refers to specific embodiments, it will be understood by those skilled in the art that various changes in form and detail may be made without departing from the subject matter set forth in the accompanying claims.

We claim:

1. A slingbar assembly comprising:
a first slingbar comprised of:
a load bearing frame having a span and a centerplane;
at least two spanwisely fixed spacers attached to the frame on opposite sides of the centerplane;
a hub attached to the frame spanwisely between two of the spacers; and
a strap assembly engaged with the hub.

2. The slingbar assembly of claim 1 wherein the hub is operable to increase or decrease a working length of the strap assembly.

3. The slingbar assembly of claim 2 including a fixation device for regulating rotation of the hub.

4. The slingbar assembly of claim 2 wherein the hub is operable to increase the working length of the strap assembly by deploying the strap assembly and to decrease the working length of the strap assembly by retracting the strap assembly.

5. The slingbar assembly of claim 4 wherein the hub is rotatable about a nonspanwise axis so that rotation of the hub in one of two rotational senses increases the working length of the strap assembly and rotation of the hub in the opposite rotational sense decreases the working length of the strap assembly.

6. The slingbar assembly of claim 5 including a latch which can be placed in a latched state which prevents rotation of the hub and an unlatched state which does not prevent rotation of the hub.

7. The slingbar assembly of claim 1 wherein the frame includes a front member, a back member transversely spaced from the front member, and wherein each spacer extends longitudinally between the front member and the back member.

8. The slingbar assembly of claim 1 wherein the spacers are distributed symmetrically and equally in number on either side of the centerplane.

9. The slingbar assembly of claim 1 wherein the strap assembly is a single strap.

10. The slingbar assembly of claim 1 wherein the strap assembly is a left strap and a right strap.

11. The slingbar assembly of claim 1 wherein the strap assembly extends spanwisely away from the hub and drapes over a spacer on one side of the centerplane and a spacer on the opposite side of the centerplane.

12. The slingbar assembly of claim 1 wherein the spacers are visually coded to indicate equality of spacer ordinality on opposite sides of the centerplane.

13. The slingbar assembly of claim 12 wherein the visual coding is color coding.

14. The slingbar assembly of claim 1 including;
a second slingbar substantially the same as the first slingbar; and
a connector extending longitudinally between and connected to the slingbars.

15. The slingbar assembly of claim 14 wherein the connector includes an attachment fixture selectively positionable along the length of the connector.

16. The slingbar assembly of claim 14 wherein the connector is removably connected to the slingbars.

17. The slingbar assembly of claim 1 wherein the spacers are cantilevered from the frame

18. A slingbar assembly comprising:
a first slingbar comprised of:
a load bearing frame having a span;
at least two spanwisely fixed spacers each having a proximal end and a distal end, the proximal end of each spacer being joined to the frame and the distal end not being joined to the frame;
a hub attached to the frame spanwisely between two of the spacers; and
a strap assembly engaged with the hub.

19. The slingbar assembly of claim 18 including:
a second slingbar substantially the same as the first slingbar; and
a connector extending longitudinally between and connected to the slingbars.

20. A slingbar assembly comprising:
a first slingbar comprised of:
a load bearing frame having a span;
at least two slots which penetrate through the frame;
a hub attached to the frame spanwisely between two of the spacers; and
a strap assembly engaged with the hub.

21. The slingbar assembly of claim 20 including:
a second slingbar substantially the same as the first slingbar; and
a connector extending longitudinally between and connected to the slingbars.
